(19) United States
(12) Patent Application Publication
(10) Pub. No.: US 2016/0332385 A1
(43) Pub. Date: Nov. 17, 2016

(54) APPARATUS AND METHOD FOR GENERATING BITMAP OF 3-DIMENSIONAL MODEL

(71) Applicant: SAMSUNG SDS CO., LTD., Seoul (KR)

(72) Inventors: Kwang-Min CHOI, Seoul (KR); Sung-Ho JANG, Seoul (KR); Jae-Young PARK, Seoul (KR); Sang-Hoon HAN, Seoul (KR)

(73) Assignee: SAMSUNG SDS CO., LTD., Seoul (KR)

(21) Appl. No.: 15/154,012

(22) Filed: May 13, 2016

(30) Foreign Application Priority Data
May 15, 2015 (KR) 10-2015-0068029

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

Disclosed are an apparatus and method for generating a bitmap of a three-dimensional (3D) model. The apparatus for generating a bitmap of a 3D model includes a plane generator configured to generate a plurality of planes including an outline of a cross section obtained by cutting a 3D model in a direction parallel to an output direction of a 3D printer, a rasterizer configured to rasterize the plurality of planes in a direction perpendicular to the output direction, calculate a weight of a pixel using a weight transition point based on outline segments constituting the outline, and determine a type of each pixel generated through the rasterization based on the weight, and a bitmap generator configured to merge pixels having the same coordinate in the output direction to generate a bitmap for a plane perpendicular to the output direction.

### CROSS-REFERENCE TO RELATED APPLICATION

This application claims priority to and the benefit of Korean Patent Application No. 10-2015-0068029, filed on May 15, 2015, the disclosure of which is incorporated herein by reference in its entirety.

### BACKGROUND

1. Field

Embodiments of the present disclosure relate to technology for generating a bitmap of a three-dimensional (3D) model for 3D printing.

2. Discussion of Related Art

A material-jetting 3D printing such as Poly jet or Multi Jet Modeling (MJM) requires a support material for supporting a floating part in a printing process in order for the part not to flow down, and needs to determine a region in which the support material is to be formed before a 3D model is printed.

In the related art, Korean Patent No. 10-0450358 discloses that, when a 3D model is output, the output may be started by a 3D printer only after dividing an output object horizontally, finding a position of a part material for each layer and then merging bitmaps of all part materials of tops of respective layers (OR), and finding a Boolean difference between the mergence bitmap and a bitmap indicating a position of a part material of a corresponding layer (XOR) to complete a support material bitmap of the corresponding layer. As a result, since positions of support material regions should be sequentially calculated beginning with a top layer in the related art, parallelization is impossible, and a very large amount of calculation is required.

Furthermore, in the related art, bitmaps of a part material and a support material of a bottom layer needed for a 3D printer to start the output may not preferably be calculated. Thus, part material regions of all upper layers should be calculated in order to know a support material region of the bottom layer.

Accordingly, in the related art, only after generating bitmaps of part materials and support materials of all layers, the 3D printer may start the output.

### SUMMARY

Embodiments of the present disclosure provide an apparatus and method for generating a bitmap of a 3D model for 3D printing.

According to an aspect of the present disclosure, there is provided an apparatus for generating a bitmap of a 3D model, the apparatus including a plane generator configured to generate a plurality of planes including an outline of a cross section obtained by cutting a 3D model in a direction parallel to an output direction of a 3D printer, a rasterizer configured to rasterize the plurality of planes in a direction perpendicular to the output direction, calculate a weight of a pixel using a weight transition point based on outline segments constituting the outline, and determine a type of each pixel generated through the rasterization based on the weight, and a bitmap generator configured to merge pixels having the same coordinate in the output direction to generate a bitmap for a plane perpendicular to the output direction.

The weight transition point may include coordinates on a coordinate axis perpendicular to the output direction corresponding to a start point positioned above a scanning line for the rasterization among start points of the outline segments, an end point positioned above the scanning line among end points of the outline segments, and an intersection point between the scanning line and each of the outline segments.

The rasterizer may increase or decrease weights of pixels on the scanning line based on the weight transition point and may calculate the weights of the pixels on the scanning line by accumulating the weights that are increased or decreased in a scanning direction of the scanning line.

The rasterizer may increase a weight of a pixel subsequent to a weight transition point corresponding to a start point positioned above the scanning line among the pixels on the scanning line with respect to the scanning direction.

The rasterizer may decrease a weight of a pixel subsequent to a weight transition point corresponding to an end point positioned above the scanning line among the pixels on the scanning line with respect to the scanning direction.

The rasterizer may increase a weight of a pixel subsequent to a weight transition point corresponding to the intersection point among the pixels on the scanning line with respect to the scanning direction when the outline segment intersects at the intersection point in an ascending manner.

The rasterizer may decrease a weight of a pixel subsequent to a weight transition point corresponding to the intersection point among the pixels on the scanning line with respect to the scanning direction when the outline segment intersects at the intersection point in a descending manner.

The rasterizer may determine whether the weight transition point corresponding to the start point positioned above the scanning line and the weight transition point corresponding to the end point positioned above the scanning line are each a valid transition point or an invalid transition point, and may increase or decrease a weight of a pixel subsequent to the valid transition point among the pixels on the scanning line with respect to the scanning direction of the scanning line.

The valid transition point may be a weight transition point corresponding to a point where one start point and another start point positioned above the scanning line are present at the same position or a point where one end point and another end point positioned above the scanning line are present at the same position.

The invalid transition point may be a weight transition point corresponding to a point where one start point and one end point positioned above the scanning line are present at the same position.

The rasterizer may determine that pixels positioned on or present inside the outline are each a pixel corresponding to a part material region.

The rasterizer may determine that a pixel having a weight greater than 0 among pixels positioned outside the outline is a pixel corresponding to a support material region.

The rasterizer may determine that a pixel having a weight equal to 0 among pixels positioned outside the outline is a pixel corresponding to an empty space region.

The rasterizer may rasterize the plurality of planes in a direction perpendicular to the output direction with respect to a coordinate in the output direction while sequentially increasing the coordinate in the output direction.

According to another aspect of the present disclosure, there is provided a method of generating a bitmap of a 3D model, the method including generating a plurality of planes including an outline of a cross section obtained by cutting a 3D model in a direction parallel to an output direction of a 3D printer, rasterizing the plurality of planes in a direction perpendicular to the output direction, calculating a weight of a pixel using a weight transition point based on outline segments constituting the outline, determining a type of each pixel generated through the rasterization based on the weight, and merging pixels having the same coordinate in the output direction to generate a bitmap for a plane perpendicular to the output direction.

The weight transition point may include coordinates on a coordinate axis perpendicular to the output direction corresponding to a start point positioned above a scanning line for the rasterization among start points of the outline segments, an end point positioned above the scanning line among end points of the outline segments, and an intersection point between the scanning line and each of the outline segments.

The calculating of a weight of a pixel may include increasing or decreasing weights of pixels on the scanning line based on the weight transition point, and calculating the weights of the pixels on the scanning line by accumulating the weights that are increased or decreased in a scanning direction of the scanning line.

The calculating of a weight of a pixel may include increasing a weight of a pixel subsequent to a weight transition point corresponding to a start point positioned above the scanning line among the pixels on the scanning line with respect to the scanning direction.

The calculating of a weight of a pixel may include decreasing a weight of a pixel subsequent to a weight transition point corresponding to an end point positioned above the scanning line among the pixels on the scanning line with respect to the scanning direction.

The calculating of a weight of a pixel may include increasing a weight of a pixel subsequent to a weight transition point corresponding to the intersection point among the pixels on the scanning line with respect to the scanning direction when the outline segment intersects at the intersection point in an ascending manner.

The calculating of a weight of a pixel may include decreasing a weight of a pixel subsequent to a weight transition point corresponding to the intersection point among the pixels on the scanning line with respect to the scanning direction when the outline segment intersects at the intersection point in a descending manner.

The calculating of a weight of a pixel may include determining whether the weight transition point corresponding to the start point positioned above the scanning line and the weight transition point corresponding to the end point positioned above the scanning line are each a valid transition point or an invalid transition point, and increasing or decreasing a weight of a pixel subsequent to the valid transition point among the pixels on the scanning line with respect to the scanning direction of the scanning line.

The valid transition point may be a weight transition point corresponding to a point where one start point and another start point positioned above the scanning line are present at the same position or a point where one end point and another end point positioned above the scanning line are present at the same position.

The invalid transition point may be a weight transition point corresponding to a point where one start point and one end point positioned above the scanning line are present at the same position.

The determining may include determining that pixels positioned on or present inside the outline are each a pixel corresponding to a part material region.

The determining may include determining that a pixel having a weight greater than 0 among pixels positioned outside the outline is a pixel corresponding to a support material region.

The determining may include determining that a pixel having a weight equal to 0 among pixels positioned outside the outline is a pixel corresponding to an empty space region.

The rasterizing may include rasterizing the plurality of planes in a direction perpendicular to the output direction with respect to a coordinate in the output direction while sequentially increasing the coordinate in the output direction.

According to still another aspect of the present disclosure, there is provided a computer program stored in a recording medium that is combined with hardware and configured to execute a method, the method including generating a plurality of planes including an outline of a cross section obtained by cutting a 3D model in a direction parallel to an output direction of a 3D printer, rasterizing the plurality of planes in a direction perpendicular to the output direction, calculating a weight of a pixel using a weight transition point based on outline segments constituting the outline, determining a type of each pixel generated through the rasterization based on the weight, and merging pixels having the same coordinate in the output direction to generate a bitmap for a plane perpendicular to the output direction.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram of an apparatus for generating a bitmap of a 3D model according to an embodiment of the present disclosure;

FIG. 2 is an exemplary diagram of generation of a plane parallel to an output direction;

FIG. 3 is an exemplary diagram of an outline included in the plane;

FIG. 4 is an exemplary diagram for describing determination of a pixel type according to an embodiment of the present disclosure;

FIG. 5 is an exemplary diagram for describing a weight of a pixel;

FIG. 6 is an exemplary diagram for describing determination of a pixel type;

FIG. 7 is an exemplary diagram for describing a weight transition point;

FIGS. 8A and 8B are exemplary diagrams for describing a valid transition point;

FIG. 9 is an exemplary diagram for describing an invalid transition point;

FIG. 10 is an exemplary diagram for describing generation of a bitmap;

FIGS. 11 and 12 are exemplary diagrams of calculation of a pixel weight using a weight transition point according to an embodiment of the present disclosure;

FIGS. 13 and 14 are exemplary diagrams of calculation of a pixel weight using a valid transition point and an invalid transition point;

FIG. 15 is a flowchart of a method of generating a bitmap of a 3D model according to an embodiment of the present disclosure;

FIG. 16 is a flowchart showing a process of determining a pixel type according to an embodiment of the present disclosure; and

FIG. 17 is a flowchart of a method of generating a bitmap of a 3D model according to another embodiment of the present disclosure.

### DETAILED DESCRIPTION OF EXEMPLARY EMBODIMENTS

Hereinafter, embodiments of the present disclosure will be described in detail with reference to the accompanying drawings. The following detailed description will be provided for better understanding a method, an apparatus, and/or a system disclosed in this specification. However, the embodiments are only exemplary, and the present disclosure is not limited thereto.

In describing embodiments of the present disclosure, when it is determined that detailed description of known techniques associated with the present disclosure would unnecessarily obscure the gist of the present disclosure, the detailed description thereof will be omitted. Also, the terms described below are defined in consideration of the functions in the present disclosure, and thus may vary depending on a user, intention of an operator, or custom. Accordingly, the definition would be made on the basis of the whole specification. The terminology used herein is for the purpose of only describing embodiments of the present disclosure, and should not be restrictive. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

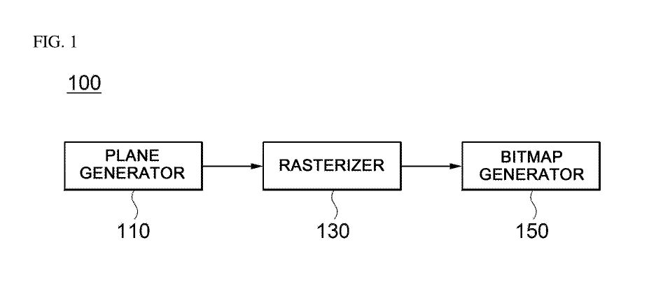

FIG. 1 is a block diagram of an apparatus for generating a bitmap of a 3D model according to an embodiment of the present disclosure.

Referring to FIG. 1, an apparatus 100 for generating a bitmap of a 3D model according to an embodiment of the present disclosure includes a plane generator 110, a rasterizer 130, and a bitmap generator 150.

The apparatus 100 for generating a bitmap of a 3D model is used to receive the 3D model and generate a bitmap for an output of a 3D printer. For example, the apparatus 100 may be implemented as a component of an apparatus having data storage and calculation capabilities, such as a server or a personal computer connected with the 3D printer over a network. However, embodiments of the present disclosure are not limited thereto. The apparatus 100 for generating a bitmap of a 3D model may be implemented as a component included in the 3D printer.

The plane generator 110 generates a plurality of planes including an outline of a cross section obtained by cutting the 3D model in a direction parallel to an output direction of the 3D printer (hereinafter referred to as an output direction), that is, in a direction parallel to a gravity direction.

For example, when it is assumed that the output direction is a z-axis direction, the plane generator 110 may generate a plurality of planes parallel to the output direction while changing a central coordinate in an x-axis or y-axis direction in any plane equation. In this case, a distance between planes may be determined by resolution of the 3D printer, but is not limited thereto. The distance may be determined by various criteria other than the resolution. In addition, the generation of the plane is not limited to the above-described example, and various well-known methods may be used rather than the above-described example.

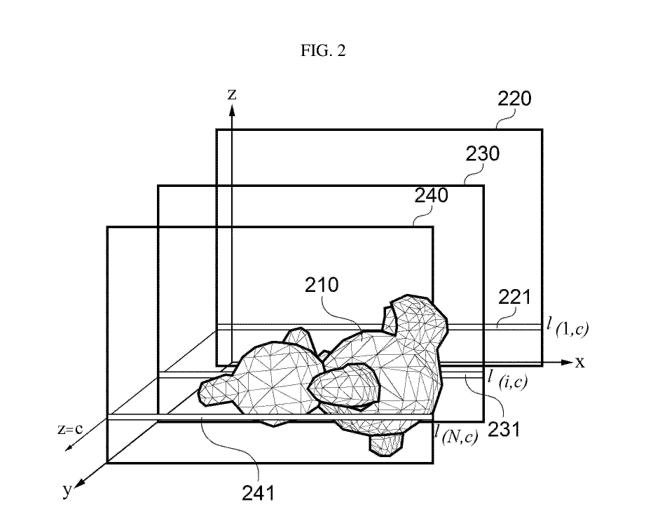

As a detailed example, referring to FIG. 2, when it is assumed that the output direction of the 3D printer is the z-axis direction, the plane generator 110 may generate a plurality of planes 220, 230, and 240 parallel to the z-axis direction in a 3D space in which a 3D model 210 is included. In an example shown in FIG. 2, there is shown that the planes 220, 230, and 240 are each generated in a y-axis direction, but is not limited thereto.

Meanwhile, the plane generator 110 may calculate intersection points between the 3D model and the generated planes and generate a sectional outline of the 3D model on each plane.

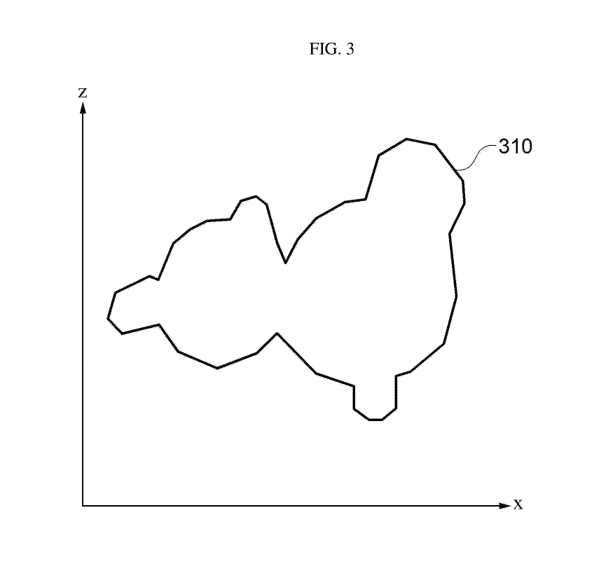

In detail, the planes 220, 230, and 240 shown in FIG. 2 may each cut the 3D model 210 in the z-axis direction. The plane generator 110 may calculate points at which the planes 220, 230, and 240 and the 3D model 210 intersect each other, and may generate a sectional outline 310 of the 3D model 210 on each of the planes 220, 230, and 240 as shown in FIG. 3.

For example, when the 3D model is a triangle mesh model, the plane generator 110 may calculate intersection points between the 3D model and the planes using technology such as an edge function, etc.

As another example, when the 3D model is a parametric model, the plane generator 110 may calculate intersection points between the 3D model and the planes using equations indicating surfaces of the 3D model and plane equations of the planes.

In addition, the plane generator 110 may use multi-dimensional indexing technology such as k-d tree, R tree, and multi-dimensional segment tree to quickly search for a basic element (e.g., a triangle) of the 3D model, which intersects each plane.

The method of generating the sectional outline of the 3D model on each plane is not limited to the above-listed examples, and thus various well-known methods may be used rather than the above-listed examples.

The rasterizer 130 rasterizes the plurality of planes generated by the plane generator 110 in a direction perpendicular to the output direction, calculates a weight of a pixel using a weight transition point that is based on an outline segment constituting an outline in which the plurality of planes and the 3D model intersect each other, and determines the type of each pixel generated through the rasterization on the basis of the calculated weight. Here, the outline segment may denote, for example, straight line elements constituting the outline in which the 3D model and the planes generated by the plane generator 110 intersect each other. As a detailed example, when the 3D model is composed of polygons, an outline in each plane is composed of straight lines in which the plane and the polygons of the 3D model intersect each other, and the straight lines may correspond to the outline segment.

In detail, referring to FIG. 2, the rasterizer 130 rasterizes the planes 220, 230, and 240 generated by the plane generator 110 along scanning lines 221, 231, and 241 in an x-axis direction perpendicular to a z-axis. In this case, according to an embodiment of the present disclosure, the rasterizer 130 may rasterize all of the planes 220, 230, and 240 while sequentially moving the scanning lines 221, 231, and 241 up from the bottom in the z-axis direction.

The pixel type may include a pixel corresponding to a part material region, a pixel corresponding to a support material region, and a pixel corresponding to an empty space. In detail, the part material region denotes a region corresponding to the 3D model that is output by the 3D printer. Also, the support material region denotes a region where a support material, which is a supporter for supporting a floating part when a 3D model is output, is formed. Also, the empty space denotes a region that does not correspond to the part material region or the support material region.

In detail, among pixels of the planes generated through the rasterization, pixels that are present on or inside an outline are filled with pixel values in a rasterization process, and the pixels filled with the pixel values correspond to the part material region. On the other hand, among pixels of the planes, pixels that are present outside the outline are not filled with pixel values in the rasterization process, and the pixels correspond to the support region or empty space.

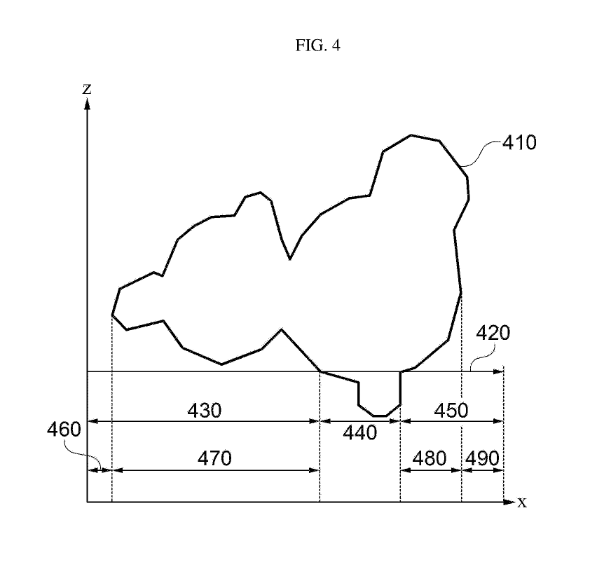

As a more detailed example, referring to FIG. 4 and assuming that the output direction is the z-axis direction and the planes are rasterized in an x-axis direction, pixels included in section 440 among pixels in a scanning line 420 are inside the outline, and thus the pixels are filled with pixel values through the rasterization. On the other hand, pixels included in section 430 and section 450 among the pixels on the scanning line 420 are present outside the outline, and then the pixels are not filled with pixel values through the rasterization. It can be seen that section 470 and section 480 correspond to the support material region in which a support material is to be formed because section 470 and section 480 correspond to a region in which an object is floating in the air when the 3D model is output, and there is an outline above in the z-axis direction, unlike section 460 and section 490.

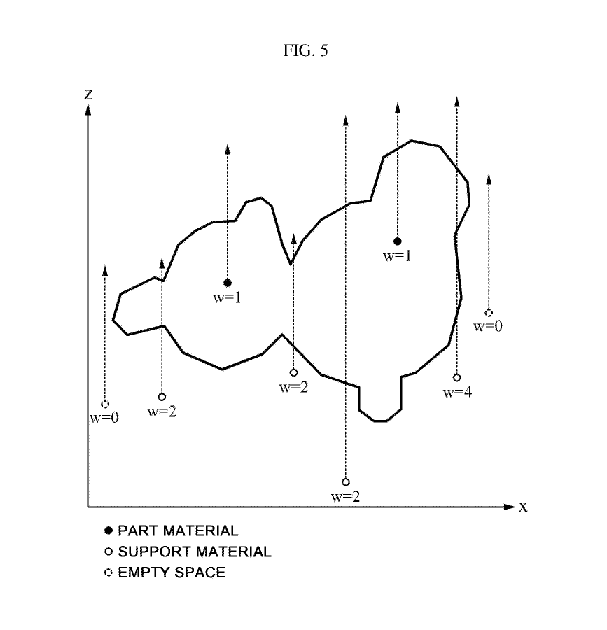

Meanwhile, FIG. 5 shows a detailed example of a pixel weight. Referring to FIG. 5, points shown in FIG. 5 indicate pixels on the plane, and w is a weight of each pixel. Assuming that the output direction is the z-axis direction in the shown example, pixels having a weight equal to 0 do not meet an outline in the z-axis direction, and pixels having a weight equal to 1 meet the outline once in the z-axis direction. Also, pixels having a weight equal to 2 meet the outline twice in the z-axis direction.

In an example shown in FIG. 5, it can be seen that the pixels having the weight equal to 1 correspond to a part material region because the pixels are inside the outline, and the pixels having the weight equal to 2 correspond to a support material region in which a support material should be formed because the pixels are outside the outline, but are included in a region in which an object is floating in the air when the 3D model is output. Also, it can be seen that the pixels having the weight equal to 0 are pixels corresponding to an empty space in which a support material need not be formed when the 3D model is output because the pixels are outside the outline.

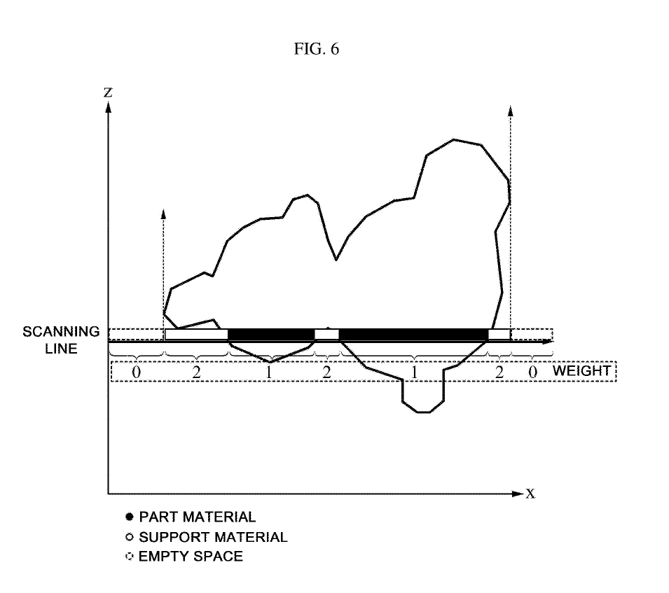

As a more detailed example, referring to FIG. 6 and assuming that the output direction is the z-axis direction and the planes are rasterized in an x-axis direction, the rasterizer 130 may distinguish the pixels on the scanning line into the pixels corresponding to the part material region, which are filled with pixel values through the rasterization, and the pixels not corresponding to the part material region, which are not filled with pixel values. In detail, in the shown example, pixels having the weight equal to 1 in a section expressed in black correspond to the pixels in the part material region.

The rasterizer 130 may determine that pixels having the weight greater than 0 among the pixels not corresponding to the part material region (that is, pixels having the weight equal to 2) are the pixels corresponding to the support material region and may determine that the pixels having the weight equal to 0 are the pixels corresponding to the empty space.

According to an embodiment of the present disclosure, the rasterizer 130 may increase or decrease the weights of the pixels on the scanning line on the basis of a weight transition point, and may calculate the weights of the pixels on the scanning line by accumulating the weights that are increased or decreased in a scanning direction of the scanning line.

Here, the weight transition point may denote, for example, a point where the weights of the pixels on the scanning line are changed with respect to the scanning direction of the scanning line for the rasterization (that is, a direction perpendicular to the output direction). In detail, the weight transition point may include coordinates on a coordinate axis perpendicular to the output direction corresponding to a start point of an outline segment positioned above the scanning line for the rasterization among start points of outline segments constituting the outline, an end point of the outline segment positioned above the scanning line among end points of the outline segments constituting the outline, and intersection points between the scanning line and the outline segments.

The start point and the end point of the outline segment may denote a point where the outline segment starts and a point where the outline segment ends with respect to the scanning direction of the scanning line for the rasterization, respectively.

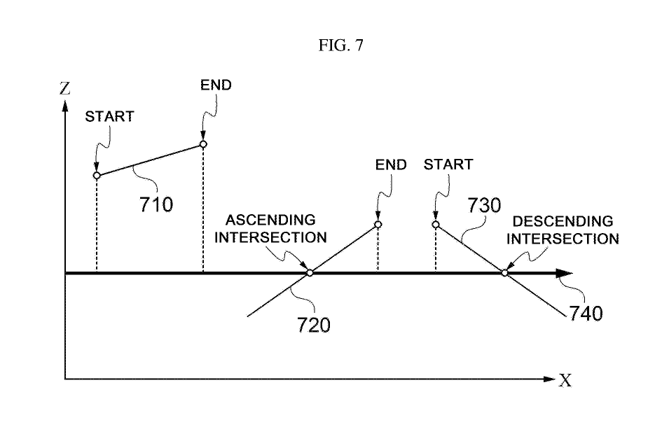

FIG. 7 shows a detailed example of a weight transition point. In an example shown in FIG. 7, straight lines 710, 720, and 730 indicate outline segments constituting the outline. Assuming that the output direction is the z-axis direction, a start point and an end point of an outline segment 710 are positioned above a scanning line 740 with respect to the output direction. Thus, x-axis coordinates corresponding to the start point and the end point of the outline segment 710 on the scanning line 740 each correspond to the weight transition point.

Since outline segments 720 and 730 intersect the scanning line 740, an intersection point between the scanning line 740 and the outline segment 720 and an intersection point between the scanning line 740 and the outline segment 730 each correspond to the weight transition point. In the shown example, ascending intersection denotes that the slope of the outline segment 720 has a positive value with respect to the scanning direction (that is, an x-axis direction) of the scanning line 740 at an intersection point with the scanning line 740, and descending intersection denotes that the slope of the outline segment 730 has a negative value with respect to the scanning line 740 at the intersection point with the scanning line 740.

An end point of the outline segment 720 is positioned above the scanning line 740 with respect to the output direction, and thus an x-axis coordinate corresponding to the end point of the outline segment 720 on the scanning line 740 corresponds to the weight transition point.

A start point of the outline segment 730 is positioned above the scanning line 740 with respect to the output direction, and thus an x-axis coordinate corresponding to the start point of the outline segment 730 on the scanning line 740 corresponds to the weight transition point.

According to an embodiment of the present disclosure, when the outline segment intersects the scanning line in an ascending manner, the rasterizer 130 may increase a weight of a pixel subsequent to a weight transition point corresponding to the intersection point with respect to the scanning direction of the scanning line among pixels on the scanning line. Also, when the outline segment intersects the scanning line in a descending manner, the rasterizer 130 may decrease a weight of a pixel subsequent to a weight transition point corresponding to the intersection point with respect to the scanning direction of the scanning line among pixels on the scanning line.

According to an embodiment of the present disclosure, among the pixels on the scanning line, the rasterizer 130 may increase a weight of a pixel after a weight transition point corresponding to a start point of an outline segment positioned above the scanning line and may decrease a weight of a pixel subsequent to a weight transition point corresponding to an end point of the outline segment positioned above the scanning line with respect to the scanning direction of the scanning line.

According to another embodiment of the present disclosure, the rasterizer 130 may determine whether the weight transition point corresponding to the start point of the outline segment positioned above the scanning line and the weight transition point corresponding to the end point of the outline segment positioned above the scanning line among the pixels on the scanning line are each a valid transition point or an invalid transition point, and may increase or decrease a weight of a pixel subsequent to the valid transition point among the pixels on the scanning line with respect to the scanning direction of the scanning line.

Here, the valid transition point may denote a weight transition point where the weight of the pixel on the scanning line actually changes with respect to the scanning direction of the scanning line among weight transition points corresponding to start points or end points of outline segments positioned above the scanning line. For example, the valid transition point may include a weight transition point corresponding to a point where a start point of one outline segment positioned above the scanning line and a start point of another outline segment are present at the same position or a point where an end point of one outline segment positioned above the scanning line and an end point of another outline segment are present at the same position.

Here, the invalid transition point may denote a point where the weight of the pixel on the scanning line does not actually change with respect to the scanning direction of the scanning line among weight transition points corresponding to start points or end points of outline segments positioned above the scanning line. For example, the invalid transition point may include a weight transition point corresponding to a point where an end point of one outline segment positioned above the scanning line and a start point of another outline segment are present at the same position.

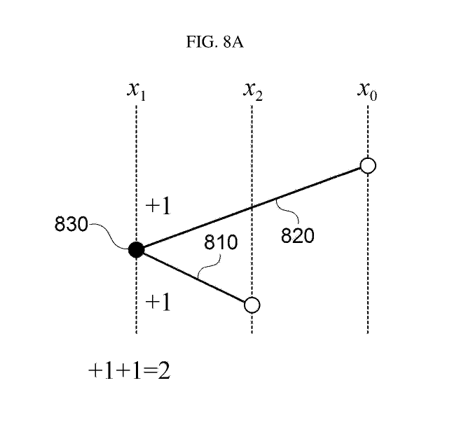

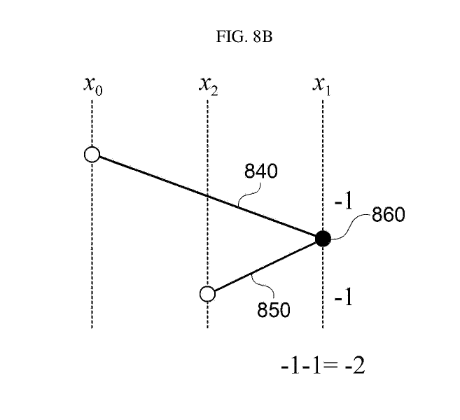

FIGS. 8A and 8B show a detailed example of a valid transition point. In FIG. 8A, start points of an outline segment 810 and an outline segment 820 are the same point 830. In this case, assuming that the point 830 is positioned above the scanning line of which the scanning direction is an x-axis direction, there are two outline segments positioned above the scanning line, beginning with x1 which is an x-axis coordinate of the point 830. Thus, it can be seen that the weight of the pixel on the scanning line actually increases by 2 at x1 with respect to the scanning direction of the scanning line. Accordingly, x1, which is the x-axis coordinate of the point 830, corresponds to the valid transition point.

In FIG. 8B, end points of an outline segment 840 and an outline segment 850 are the same point 860. In this case, assuming that the point 860 is positioned above the scanning line of which the scanning direction is an x-axis direction, there is no outline segment positioned above the scanning line, beginning with x1 which is an x-axis coordinate of the point 860. Thus, it can be seen that the weight of the pixel on the scanning line actually decreases by 2 at x1 with respect to the scanning direction of the scanning line. Accordingly, x1, which is the x-axis coordinate of the point 860, corresponds to the valid transition point.

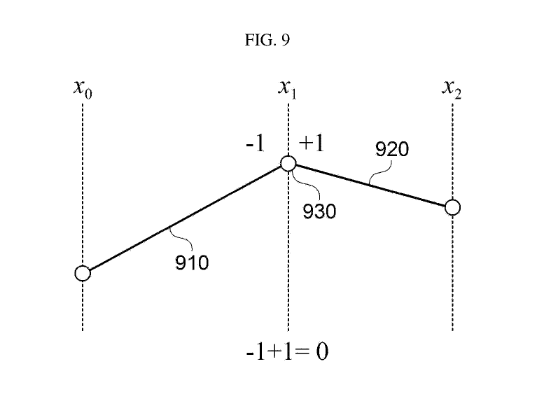

FIG. 9 shows a detailed example of an invalid transition point. In FIG. 9, an end point of an outline segment 910 and a start point of an outline segment 920 are the same point 930. In this case, assuming that the point 930 is positioned above the scanning line of which the scanning direction is an x-axis direction, the number of outline segments positioned above the scanning line does not change, beginning with x1 which is an x-axis coordinate of the point 930. Thus, it can be seen that the weight of the pixel on the scanning line does not actually increase at x1 with respect to the scanning direction of the scanning line. Accordingly, x1, which is the x-axis coordinate of the point 930, corresponds to the invalid transition point.

Referring again to FIG. 1, the bitmap generator 150 merges pixels generated through the rasterization to generate a bitmap for any plane perpendicular to the output direction.

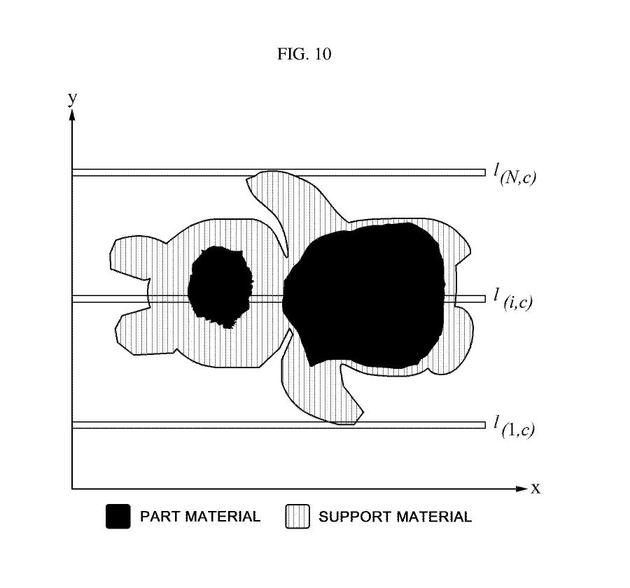

For example, as shown in FIG. 10, the bitmap generator 150 may merge pixels having a coordinate c in the z-axis direction, which is an output direction, among pixels of planes generated through the rasterization to generate a bitmap for a plane that has the z-axis coordinate c and is perpendicular to the output direction. This bitmap corresponds to a bitmap for a layer that is output in the c-th order when the output is performed by the 3D printer.

According to an embodiment of the present disclosure, the bitmap generator 150 may sequentially generate a bitmap for a plane perpendicular to an output direction with respect to a coordinate value of the output direction while increasing the coordinate value of the output direction from the bottom.

For example, as shown in FIG. 10, the bitmap generator 150 may generate a bitmap for a plane that has the z-axis coordinate c and is perpendicular to the output direction and then merge pixels having the z-axis coordinate c+1 to generate a bitmap for a plane that has the z-axis coordinate c+1 and is perpendicular to the output direction. This bitmap corresponds to a bitmap for a layer that is output in the (c+1)th order when the output is performed by the 3D printer.

In this way, according to an embodiment of the present disclosure, bitmaps may be sequentially generated when the output is performed by the 3D printer, beginning with a bitmap for the bottom layer. Accordingly, the output may be started immediately even before a bitmap for another output layer is generated, and bitmap information regarding layers that has been completely output may be directly deleted from a memory, thus reducing a memory usage to store the bitmap.

In an embodiment of the present disclosure, the plane generator 110, the rasterizer 130, and the bitmap generator 150 shown in FIG. 1 may be implemented in a computing device including at least one processor and a computer-readable recording medium connected with the processor. The computer-readable recording medium may be inside or outside the processor, and may be connected with the processor using various well-known means. The processor in the computing device may allow the computing device to operate according to an exemplary embodiment disclosed in this specification. For example, the processor may execute an instruction stored in the computer-readable recording medium. The instruction stored in the computer-readable recording medium may be configured to allow the computing device to perform operations according to an exemplary embodiment disclosed in this specification.

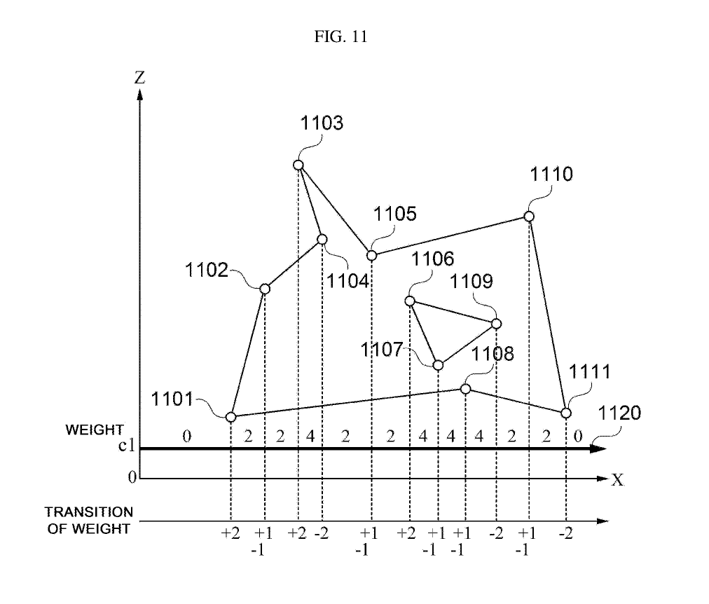

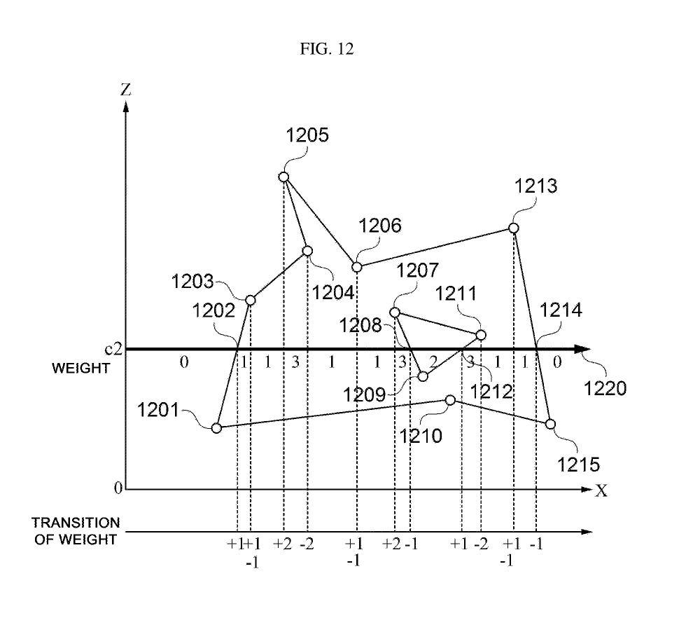

FIGS. 11 and 12 are exemplary diagrams of calculation of a pixel weight using a weight transition point according to an embodiment of the present disclosure.

In FIGS. 11 and 12, it is assumed that the output direction is the z-axis direction and the scanning direction of the scanning line for the rasterization is an x-axis direction. Furthermore, it is also assumed that a weight of a pixel corresponding to a start point of the scanning line is 0 and the weight is increased or decreased by 1 at each weight transition point. In FIGS. 11 and 12, the straight lines connected on an x-z plane indicate outline segments constituting an outline.

Referring to FIG. 11, the rasterizer 130 performs rasterization in an x-axis direction, with respect to a z-axis coordinate c1. In the shown example, a point 1101 is a point where start points of two outline segments are present at the same position. Accordingly, an x-axis coordinate corresponding to the point 1101 on a scanning line 1120 is a point where two weight transition points at which a weight of a pixel is to be increased are present at the same position. Accordingly, the sum of weight increments is 2. Thus, among the pixels on the scanning line 1120, the rasterizer 130 increases weights of pixels subsequent to the pixel corresponding to the x-axis coordinate of the point 1101 by 2 with respect to the scanning direction (that is, an x-axis direction) of the scanning line 1120, compared to weights of previous pixels.

A point 1102 is a point where an end point of one outline segment and a start point of another outline segment are present at the same position. Accordingly, an x-axis coordinate corresponding to the point 1102 on the scanning line 1120 is a point where a weight transition point where a weight of a pixel is to be increased and a weight transition point where a weight of a pixel is to be decreased are present at the same position. Accordingly, the sum of weight increments is 0. Thus, among the pixels on the scanning line 1120, the rasterizer 130 keeps weights of pixels subsequent to a pixel corresponding to an x-axis coordinate of the point 1102 the same as weights of previous pixels, with respect to the scanning direction (that is, an x-axis direction) of the scanning line 1120.

Like the point 1101, a point 1103 is a point where start points of two outline segments are present at the same position. Accordingly, among the pixels on the scanning line 1120, the rasterizer 130 increases weights of pixels subsequent to a pixel corresponding to an x-axis coordinate of the point 1103 by 2 with respect to the scanning direction (that is, an x-axis direction) of the scanning line 1120, compared to weights of previous pixels.

A point 1104 is a point where end points of two outline segments are present at the same position. Accordingly, an x-axis coordinate corresponding to the point 1104 on the scanning line 1120 is a point where two weight transition points at which a weight of a pixel is to be decreased are present. Accordingly, the sum of weight increments is −2. Accordingly, among the pixels on the scanning line 1120, the rasterizer 130 decreases weights of pixels subsequent to the pixel corresponding to the x-axis coordinate of the point 1104 by 2 with respect to the scanning direction (that is, an x-axis direction) of the scanning line 1120.

In this way, the rasterizer 130 may find weight increments with respect to weight transition points corresponding to points 1105, 1106, 1107, 1108, 1109, 1110, and 1111 and may increase or decrease weights of pixels subsequent to the weight transition points with respect to the scanning direction (that is, an x-axis direction) of the scanning line 1120 among the pixels on the scanning line 1120.

Referring to FIG. 12, the rasterizer 130 may perform rasterization with respect to the z-axis coordinate c1 as shown in FIG. 11, and then may increase a z-axis coordinate of a scanning line 1220 to c2 and perform rasterization in an x-axis direction with respect to c2. In the shown example, a point 1201 is a start point of two outline segments, and a point 1215 is an end point of two outline segments, but is present below the scanning line 1220. Thus, x-axis coordinates corresponding to the point 1201 and the point 1215 do not correspond to weight transition points.

Also, a point 1209 and a point 1210 are each an end point of one outline segment and also a start point of another outline segment, but are present below the scanning line 1220. Thus, x-axis coordinates corresponding to the point 1209 and the point 1210 do not correspond to the weight transition points.

At a point 1202 and a point 1212, outline segments intersect the scanning line 1220 in an ascending manner. Thus, x-axis coordinates corresponding to the point 1202 and the point 1212 are weight transition points at which the weight of the pixel is to be increased. Accordingly, among the pixels on the scanning line 1220, the rasterizer 130 increases weights of pixels subsequent to the pixels corresponding to the x-axis coordinates of the point 1202 and the point 1212 by 1 with respect to the scanning direction (that is, an x-axis direction) of the scanning line 1220, compared to weights of previous pixels.

At a point 1208 and a point 1214, outline segments intersect the scanning line 1220 in a descending manner. Thus, x-axis coordinates corresponding to the point 1208 and the point 1214 are weight transition points at which the weight of the pixel is to be decreased. Accordingly, among the pixels on the scanning line 1220, the rasterizer 130 decreases weights of pixels subsequent to the pixels corresponding to the x-axis coordinates of the point 1208 and the point 1214 by 1 with respect to the scanning direction (that is, an x-axis direction) of the scanning line 1220, compared to weights of previous pixels.

Meanwhile, the rasterizer 130 may calculate weights of pixels at weight transition points corresponding to points 1203, 1204, 1205, 1206, 1207, 1211, and 1213 in the same way as shown in FIG. 11.

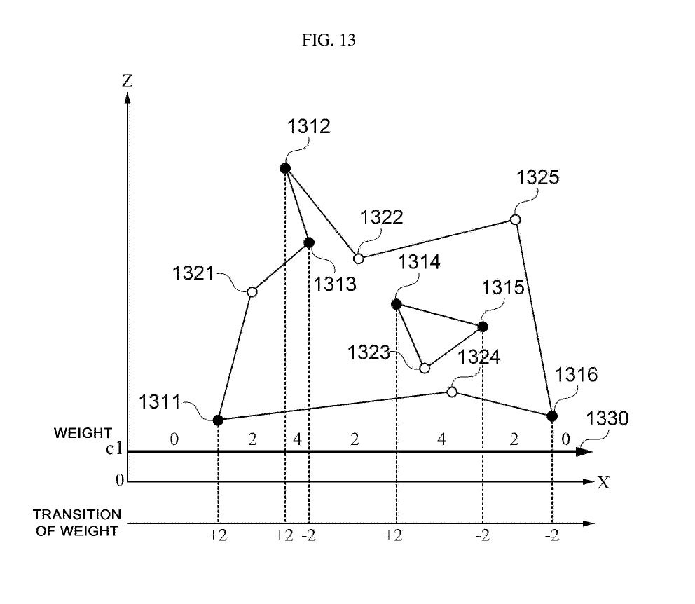

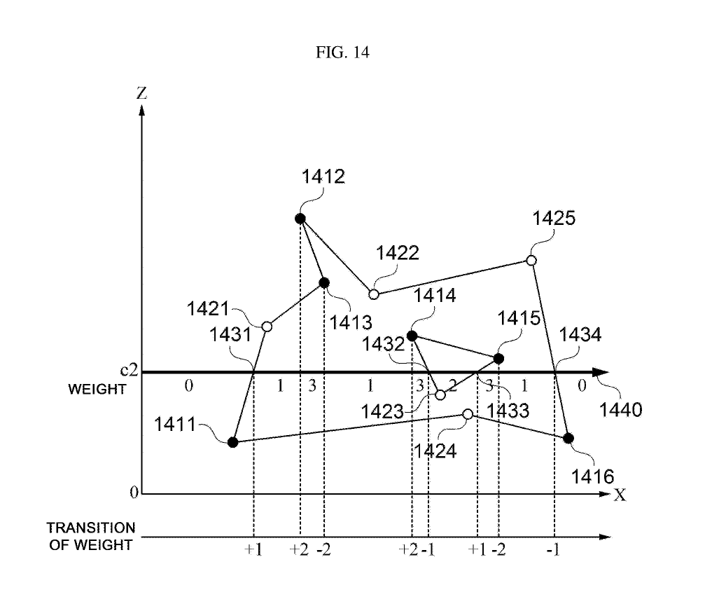

FIGS. 13 and 14 are exemplary diagrams of calculation of a pixel weight using a valid transition point and an invalid transition point.

In FIGS. 13 and 14, it is assumed that the output direction is the z-axis direction and the scanning direction of the scanning line for the rasterization is an x-axis direction. Furthermore, it is also assumed that a weight of a pixel corresponding to a start point of a scanning line is 0 and the weight is increased or decreased by 1 at each weight transition point. In FIGS. 13 and 14, the straight lines connected on an x-z plane indicate outline segments constituting an outline.

Referring to FIG. 13, points 1311, 1312, and 1314 are present above a scanning line 1330 with respect to the z-axis direction, and each of the points is a point where start points of two outline segments are present at the same position. Accordingly, x-axis coordinates corresponding to the points 1311, 1312, and 1314 correspond to valid transition points, and the sum of weight increments at the valid transition points is 2. Accordingly, among the pixels on the scanning line 1330, the rasterizer 130 increases weights of pixels subsequent to the pixels corresponding to the x-axis coordinates of the points 1311, 1312, and 1314 by 2 with respect to the scanning direction (that is, an x-axis direction) of the scanning line 1330, compared to weights of previous pixels.

Points 1313, 1315, and 1316 are present above the scanning line 1330 with respect to the z-axis direction, and each of the points is a point where end points of two outline segments are present at the same position. Accordingly, x-axis coordinates corresponding to the points 1313, 1315, and 1316 correspond to valid transition points, and the sum of weight increments at the valid transition points is −2. Accordingly, among the pixels on the scanning line 1330, the rasterizer 130 decreases weights of pixels subsequent to the pixels corresponding to the x-axis coordinates of the points 1313, 1315, and 1316 by 2 with respect to the scanning direction (that is, an x-axis direction) of the scanning line 1330, compared to weights of previous pixels.

Points 1321, 1322, 1323, 1324, and 1325 are present above the scanning line 1330 with respect to the z-axis direction, and each of the points is a point where a start point of one outline segment and an end point of another outline segment are present at the same position. Thus, x-axis coordinates corresponding to the points 1321, 1322, 1323, 1324, and 1325 correspond to invalid transition points. Accordingly, unlike an example shown in FIG. 11, the rasterizer 130 does not calculate a pixel weight change on the scanning line 1330 at the x-axis coordinates corresponding to the points 1321, 1322, 1323, 1324, and 1325. Compared to an example shown in FIG. 11, a pixel weight variation may be calculated only at a valid transition point in order to calculate weights of pixels on a scanning line. Thus, it is possible to decrease the amount of calculation required to calculate the weights.

Referring to FIG. 14, the rasterizer 130 may perform rasterization with respect to the z-axis coordinate c1 as shown in FIG. 13, and then may increase a z-axis coordinate of a scanning line 1440 to c2 and perform rasterization in an x-axis direction with respect to c2. In the shown example, a point 1411 is a start point of two outline segments, and a point 1416 is an end point of two outline segments, but both of the points are present below the scanning line 1440. Thus, x-axis coordinates corresponding to the point 1411 and the point 1416 do not correspond to weight transition points.

Also, a point 1423 and a point 1424 are each an end point of one outline segment and also a start point of another outline segment, but are present below the scanning line 1440. Thus, x-axis coordinates corresponding to the point 1423 and the point 1424 do not correspond to the weight transition points.

At a point 1431 and a point 1433, outline segments intersect the scanning line 1440 in an ascending manner. Thus, x-axis coordinates corresponding to the point 1431 and the point 1433 are weight transition points at which the weight of the pixel is to be increased. Accordingly, among the pixels on the scanning line 1440, the rasterizer 130 increases weights of pixels subsequent to the pixels corresponding to the x-axis coordinates of the point 1431 and the point 1433 by 1 with respect to the scanning direction (that is, an x-axis direction) of the scanning line 1440, compared to weights of previous pixels.

At a point 1432 and a point 1434, outline segments intersect the scanning line 1440 in a descending manner. Thus, x-axis coordinates corresponding to the point 1432 and the point 1434 are weight transition points at which the weight of the pixel is to be decreased. Accordingly, among the pixels on the scanning line 1440, the rasterizer 130 decreases weights of pixels subsequent to the pixels corresponding to the x-axis coordinates of the point 1432 and the point 1434 by 1 with respect to the scanning direction (that is, an x-axis direction) of the scanning line 1440, compared to weights of previous pixels.

Points 1421, 1422, and 1425 are present above the scanning line 1440 with respect to the z-axis direction, and each of the points is a point where a start point of one outline segment and an end point of another outline segment are present at the same position. Thus, x-axis coordinates corresponding to the points 1421, 1422, and 1425 correspond to invalid transition points. Accordingly, the rasterizer 130 does not calculate a pixel weight change on the scanning line 1440 at the x-axis coordinates corresponding to the points 1421, 1422, and 1425.

Points 1412 and 1414 are present above the scanning line 1440 with respect to the z-axis direction, and each of the points is a point where start points of two outline segments are present at the same position. Accordingly, x-axis coordinates corresponding to the points 1412 and 1414 correspond to valid transition points, and the sum of weight increments at the valid transition points is 2. Accordingly, among the pixels on the scanning line 1440, the rasterizer 130 increases weights of pixels subsequent to the pixels corresponding to the x-axis coordinates of the points 1412 and 1414 by 2 with respect to the scanning direction (that is, an x-axis direction) of the scanning line 1440, compared to weights of previous pixels.

Points 1413 and 1415 are present above the scanning line 1440 with respect to the z-axis direction, and each of the points is a point where end points of two outline segments are present at the same position. Accordingly, x-axis coordinates corresponding to the points 1413 and 1415 correspond to valid transition points, and the sum of weight increments at the valid transition points is −2. Accordingly, among the pixels on the scanning line 1440, the rasterizer 130 decreases weights of pixels subsequent to the pixels corresponding to the x-axis coordinates of the points 1413 and 1415 by 2 with respect to the scanning direction (that is, an x-axis direction) of the scanning line 1440, compared to weights of previous pixels.

Comparing the example shown in FIG. 14 and the example shown in FIG. 12, in the example shown in FIG. 14, as the scanning line moves up, a weight variation may be calculated only at a valid transition point and a weight transition point corresponding to an intersection point between the outline segment and the scanning line in order to calculate weights of pixels on the scanning line. Thus, it is possible to decrease the amount of calculation required to calculate the weights, compared to the example shown in FIG. 12.

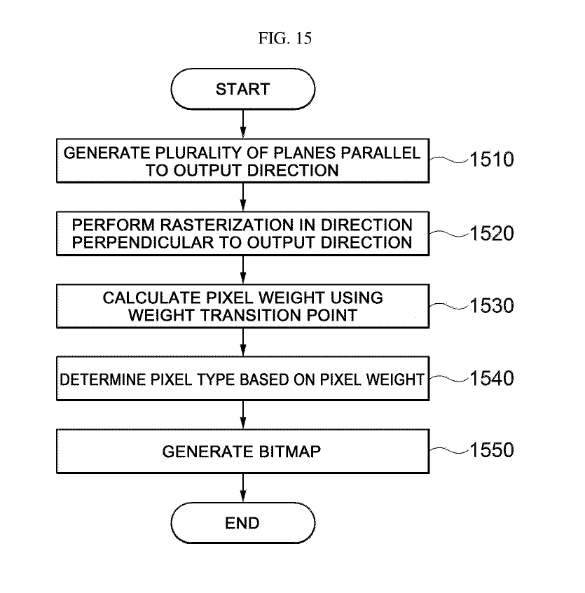

FIG. 15 is a flowchart of a method of generating a bitmap of a 3D model according to an embodiment of the present disclosure. The method shown in FIG. 15 may be performed, for example, by the apparatus 100 for generating a bitmap of a 3D model.

Referring to FIG. 15, the apparatus 100 for generating a bitmap of a 3D model generates a plurality of planes including an outline of a cross section obtained by cutting the 3D model in a direction parallel to an output direction of the 3D printer (S1510).

Subsequently, the apparatus 100 for generating a bitmap of a 3D model rasterizes the generated plurality of planes in a direction perpendicular to the output direction (S1520).

Subsequently, the apparatus 100 for generating a bitmap of a 3D model calculates a weight of a pixel using a weight transition point based on outline segments constituting the outline in which the plurality of planes intersect the 3D model (S1530).

Here, the weight transition point may include, for example, coordinates on a coordinate axis perpendicular to the output direction corresponding to a start point of an outline segment positioned above the scanning line for the rasterization among start points of outline segments constituting the outline, an end point of the outline segment positioned above the scanning line among end points of the outline segments constituting the outline, and intersection points between the scanning line and the outline segments.

According to an embodiment of the present disclosure, the apparatus 100 for generating a bitmap of a 3D model may increase or decrease the weights of the pixels on the scanning line on the basis of the weight transition point, and may calculate the weights of the pixels on the scanning line by accumulating the weights that are increased or decreased in a scanning direction of the scanning line.

In detail, according to an embodiment of the present disclosure, when an outline segment intersects the scanning line in an ascending manner, the apparatus 100 for generating a bitmap of a 3D model may increase a weight of a pixel subsequent to a weight transition point corresponding to the intersection point with respect to the scanning direction of the scanning line among pixels on the scanning line. Also, when the outline segment intersects the scanning line in a descending manner, the apparatus 100 for generating a bitmap of a 3D model may decrease a weight of a pixel subsequent to a weight transition point corresponding to the intersection point with respect to the scanning direction of the scanning line among pixels on the scanning line.

According to an embodiment of the present disclosure, among the pixels on the scanning line, the apparatus 100 for generating a bitmap of a 3D model may increase a weight of a pixel subsequent to a weight transition point corresponding to a start point of an outline segment positioned above the scanning line with respect to the scanning direction of the scanning line and may decrease a weight of a pixel subsequent to a weight transition point corresponding to an end point of the outline segment positioned above the scanning line.

According to another embodiment of the present disclosure, the apparatus 100 for generating a bitmap of a 3D model may determine whether the weight transition point corresponding to the start point of the outline segment positioned above the scanning line and the weight transition point corresponding to the end point of the outline segment positioned above the scanning line among the pixels on the scanning line are each a valid transition point or an invalid transition point, and may increase or decrease a weight of a pixel subsequent to the valid transition point among the pixels on the scanning line with respect to the scanning direction of the scanning line.

Subsequently, the apparatus 100 for generating a bitmap of a 3D model determines the type of each pixel generated through the rasterization on the basis of the calculated weight (S1540).

The above-described rasterization and pixel type determination may be sequentially performed on the plurality of planes, but are not limited thereto. The rasterization and pixel type determination may also be performed in parallel on one or more planes.

Subsequently, the apparatus 100 for generating a bitmap of a 3D model merges pixels having the same coordinate in an output direction to generate a bitmap for a plane perpendicular to the output direction (S1550).

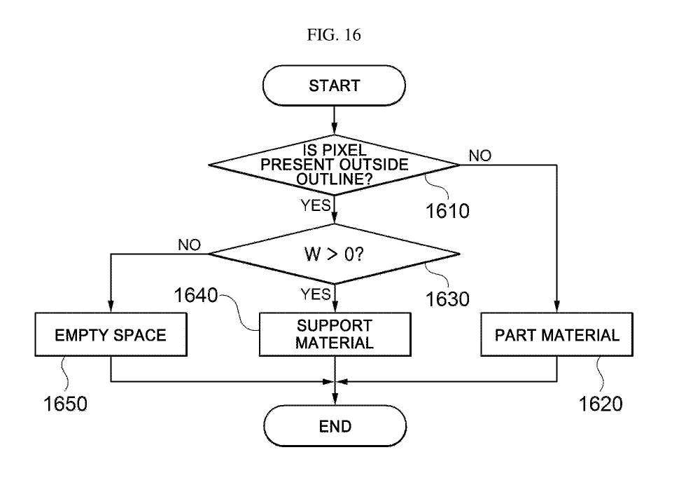

FIG. 16 is a flowchart showing a process of determining a pixel type according to an embodiment of the present disclosure.

The method shown in FIG. 16 may be performed, for example, by the apparatus 100 for generating a bitmap of a 3D model.

Referring to FIG. 16, the apparatus 100 for generating a bitmap of a 3D model determines whether the pixel generated through the rasterization is outside an outline (S1610).

For example, the pixel inside the outline is filled with a pixel value through the rasterization, and the pixel outside the outline is not filled with a pixel value through the rasterization. Thus, the apparatus 100 for generating a bitmap of a 3D model may determine whether the generated pixel is outside the outline on the basis of pixel values of pixels.

When the pixel generated through the rasterization is on or inside the outline, the apparatus 100 for generating a bitmap of a 3D model determines that the pixel is a pixel corresponding to a part material region (S1620).

On the other hand, when the pixel generated through the rasterization is outside the outline, the apparatus 100 for generating a bitmap of a 3D model determines whether a weight of each pixel is greater than 0 (S1630) and determines that the pixel is a pixel corresponding to a support material region when the weight is greater than 0 (S1640).

When the calculated weight is 0, the apparatus 100 for generating a bitmap of a 3D model determines that the pixel is a pixel corresponding to an empty space (S1650).

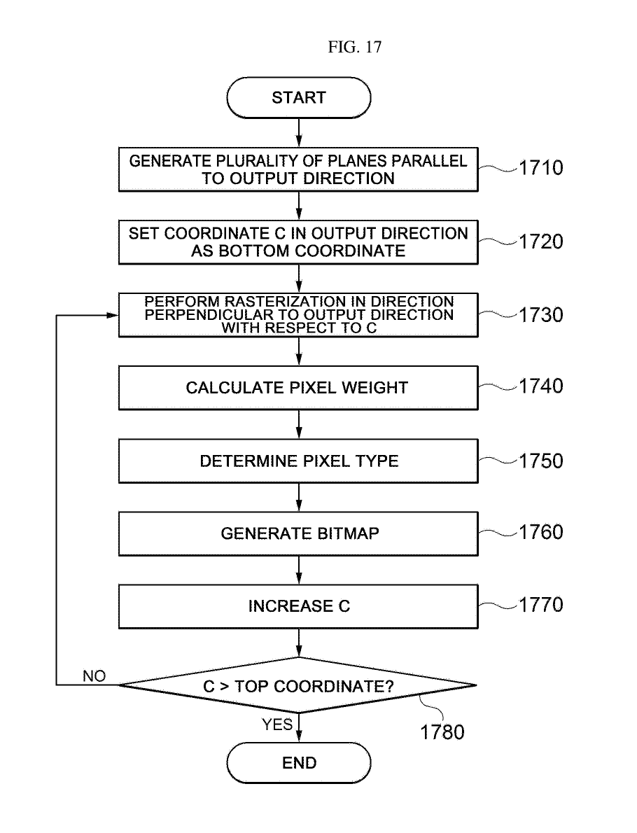

FIG. 17 is a flowchart of a method of generating a bitmap of a 3D model according to another embodiment of the present disclosure.

The method shown in FIG. 17 may be performed, for example, by the apparatus 100 for generating a bitmap of a 3D model.

Referring to FIG. 17, the apparatus 100 for generating a bitmap of a 3D model generates a plurality of planes including an outline of a cross section obtained by cutting the 3D model in a direction parallel to an output direction of the 3D printer (S1710).

Subsequently, the apparatus 100 for generating a bitmap of a 3D model sets a coordinate in an output direction as the bottom coordinate (S1720) and rasterizes a plurality of planes generated on the basis of the bottom coordinate in a direction perpendicular to the output direction (S1730).

Subsequently, the apparatus 100 for generating a bitmap of a 3D model calculates a weight of a pixel using a weight transition point based on outline segments constituting the outline in which the plurality of planes intersect the 3D model (S1740). In this case, the weight calculation may be performed, for example, according to the example described with reference to FIG. 15.

Subsequently, the apparatus 100 for generating a bitmap of a 3D model determines the type of each pixel generated through the rasterization using the calculated weight of the pixel (S1750). In this case, the pixel type determination may be performed, for example, by the example described with reference to FIG. 16.

Subsequently, the apparatus 100 for generating a bitmap of a 3D model merges the generated pixels to generate a bitmap for a plane perpendicular to the output direction (S1760).

Subsequently, the apparatus 100 for generating a bitmap of a 3D model increases a coordinate in the output direction (S1770). In this case, the amount of increase may use a predetermined value.

In this case, when the increased coordinate in the output direction is equal to or less than the top coordinate of the 3D model (S1780), the apparatus 100 for generating a bitmap of a 3D model repeatedly performs steps S1730 to S1770.

On the other hand, when the increased coordinate in the output direction is greater than the top coordinate of the 3D model (S1780), the apparatus 100 for generating a bitmap of a 3D model ends the rasterization and the bitmap generation.

In the flowcharts shown in FIGS. 15 to 17, the method has been described to have a plurality of steps. However, at least some of the steps may be performed in an exchanged order, performed in combination with another step, omitted, divided into sub-steps and then performed, or performed in addition to one or more steps that are not shown.

According to embodiments of the present disclosure, in order to determine a position of a support material in any output layer, bitmaps in all layers positioned above the output layer need not be generated. Thus, it is possible to significantly reduce a calculation load used to calculate the position of the support material.

Furthermore, by allowing a bitmap in the bottom layer needed for a 3D printer to start an output to be preferentially generated, it is possible to reduce bitmap information to be maintained in a memory and reduce a standby time for the output.

Embodiments of the present disclosure may include a computer-readable recording medium including a program for performing methods described in this specification on a computer. The computer-readable recording medium may include any one or a combination of a program instruction, a local data file, a local data structure, etc. The medium may be designed and configured specifically for the present disclosure or can be typically available in the field of computer software. Examples of the computer-readable recording medium include a magnetic medium, such as a hard disk, a floppy disk, and a magnetic tape, an optical recording medium, such as a CD-ROM and a DVD, a magneto-optical medium, such as a floptical disk, and a hardware device specially configured to store and perform a program instruction, such as a ROM, a RAM, and a flash memory. Examples of the program instruction may include a high-level language code executable by a computer with an interpreter, in addition to a machine language code made by a compiler.

Although exemplary embodiments of the present disclosure have been described in detail, it will be understood by those skilled in the art that various changes may be made without departing from the spirit or scope of the present disclosure. Thus, the scope of the present disclosure is to be determined by the following claims and their equivalents, and shall not be restricted or limited by the foregoing detailed description.

What is claimed is:

1. An apparatus for generating a bitmap of a 3D model, the apparatus comprising:
a plane generator configured to generate a plurality of planes including an outline of a cross section obtained by cutting a 3D model in a direction parallel to an output direction of a 3D printer;
a rasterizer configured to rasterize the plurality of planes in a direction perpendicular to the output direction, calculate a weight of a pixel using a weight transition point based on outline segments constituting the outline, and determine a type of each pixel generated through the rasterization based on the weight; and
a bitmap generator configured to merge pixels having the same coordinate in the output direction to generate a bitmap for a plane perpendicular to the output direction.

2. The apparatus of claim 1, wherein the weight transition point includes coordinates on a coordinate axis perpendicular to the output direction corresponding to a start point positioned above a scanning line for the rasterization among start points of the outline segments, an end point positioned above the scanning line among end points of the outline segments, and an intersection point between the scanning line and each of the outline segments.

3. The apparatus of claim 2, wherein the rasterizer increases or decreases weights of pixels on the scanning line based on the weight transition point, and calculates the weights of the pixels on the scanning line by accumulating the weights that are increased or decreased in a scanning direction of the scanning line.

4. The apparatus of claim 3, wherein the rasterizer increases a weight of a pixel subsequent to a weight transition point corresponding to a start point positioned above the scanning line among the pixels on the scanning line with respect to the scanning direction.

5. The apparatus of claim 3, wherein the rasterizer decreases a weight of a pixel subsequent to a weight transition point corresponding to an end point positioned above the scanning line among the pixels on the scanning line with respect to the scanning direction.

6. The apparatus of claim 3, wherein the rasterizer increases a weight of a pixel subsequent to a weight transition point corresponding to the intersection point among the pixels on the scanning line with respect to the scanning direction when the outline segment intersects at the intersection point in an ascending manner.

7. The apparatus of claim 3, wherein the rasterizer decreases a weight of a pixel subsequent to a weight transition point corresponding to the intersection point among the pixels on the scanning line with respect to the scanning direction when the outline segment intersects at the intersection point in a descending manner.

8. The apparatus of claim 3, wherein the rasterizer determines whether the weight transition point corresponding to the start point positioned above the scanning line and the weight transition point corresponding to the end point positioned above the scanning line are each a valid transition point or an invalid transition point, and increases or decreases a weight of a pixel subsequent to the valid transition point among the pixels on the scanning line with respect to the scanning direction of the scanning line.

9. The apparatus of claim 8, wherein the valid transition point is a weight transition point corresponding to a point where one start point and another start point positioned above the scanning line are present at the same position or a point where one end point and another end point positioned above the scanning line are present at the same position.

10. The apparatus of claim 8, wherein the invalid transition point is a weight transition point corresponding to a point where one start point and one end point positioned above the scanning line are present at the same position.

11. The apparatus of claim 1, wherein the rasterizer determines that pixels positioned on or present inside the outline are each a pixel corresponding to a part material region.

12. The apparatus of claim 1, wherein the rasterizer determines that a pixel having a weight greater than 0 among pixels positioned outside the outline is a pixel corresponding to a support material region.

13. The apparatus of claim 1, wherein the rasterizer determines that a pixel having a weight equal to 0 among pixels positioned outside the outline is a pixel corresponding to an empty space region.

14. The apparatus of claim 1, wherein the rasterizer rasterizes the plurality of planes in a direction perpendicular to the output direction with respect to a coordinate in the output direction while sequentially increasing the coordinate in the output direction.

15. A method of generating a bitmap of a 3D model, the method comprising:
generating a plurality of planes including an outline of a cross section obtained by cutting a 3D model in a direction parallel to an output direction of a 3D printer;
rasterizing the plurality of planes in a direction perpendicular to the output direction;
calculating a weight of a pixel using a weight transition point based on outline segments constituting the outline;
determining a type of each pixel generated through the rasterization based on the weight; and
merging pixels having the same coordinate in the output direction to generate a bitmap for a plane perpendicular to the output direction.

16. The method of claim 15, wherein the weight transition point includes coordinates on a coordinate axis perpendicular to the output direction corresponding to a start point positioned above a scanning line for the rasterization among start points of the outline segments, an end point positioned above the scanning line among end points of the outline segments, and an intersection point between the scanning line and each of the outline segments.

17. The method of claim 16, wherein the calculating of a weight of a pixel comprises increasing or decreasing weights of pixels on the scanning line based on the weight transition point, and calculating the weights of the pixels on the scanning line by accumulating the weights that are increased or decreased in a scanning direction of the scanning line.

18. The method of claim 17, wherein the calculating of a weight of a pixel comprises increasing a weight of a pixel subsequent to a weight transition point corresponding to a start point positioned above the scanning line among the pixels on the scanning line with respect to the scanning direction.

19. The method of claim 17, wherein the calculating of a weight of a pixel comprises decreasing a weight of a pixel subsequent to a weight transition point corresponding to an end point positioned above the scanning line among the pixels on the scanning line with respect to the scanning direction.

20. The method of claim 17, wherein the calculating of a weight of a pixel comprises increasing a weight of a pixel subsequent to a weight transition point corresponding to the intersection point among the pixels on the scanning line with respect to the scanning direction when the outline segment intersects at the intersection point in an ascending manner.

21. The method of claim 17, wherein the calculating of a weight of a pixel comprises decreasing a weight of a pixel subsequent to a weight transition point corresponding to the intersection point among the pixels on the scanning line with respect to the scanning direction when the outline segment intersects at the intersection point in a descending manner.

22. The method of claim 17, wherein the calculating of a weight of a pixel comprises determining whether the weight transition point corresponding to the start point positioned above the scanning line and the weight transition point corresponding to the end point positioned above the scanning line are each a valid transition point or an invalid transition point, and increasing or decreasing a weight of a pixel subsequent to the valid transition point among the pixels on the scanning line with respect to the scanning direction of the scanning line.

23. The method of claim 22, wherein the valid transition point is a weight transition point corresponding to a point where one start point and another start point positioned above the scanning line are present at the same position or a point where one end point and another end point positioned above the scanning line are present at the same position.

24. The method of claim 22, wherein the invalid transition point is a weight transition point corresponding to a point where one start point and one end point positioned above the scanning line are present at the same position.

25. The method of claim 15, wherein the determining comprises determining that pixels positioned on or present inside the outline are each a pixel corresponding to a part material region.

26. The method of claim 15, wherein the determining comprises determining that a pixel having a weight greater than 0 among pixels positioned outside the outline is a pixel corresponding to a support material region.

27. The method of claim 15, wherein the determining comprises determining that a pixel having a weight equal to 0 among pixels positioned outside the outline is a pixel corresponding to an empty space region.

28. The method of claim 15, wherein the rasterizing comprises rasterizing the plurality of planes in a direction perpendicular to the output direction with respect to a coordinate in the output direction while sequentially increasing the coordinate in the output direction.
